(19) United States
(12) Patent Application Publication
(10) Pub. No.: US 2019/0378086 A1
(43) Pub. Date: Dec. 12, 2019

(54) PASSIVE CROWDSOURCED PACKAGE DELIVERY

(71) Applicant: Jade O. Laye, Fresno, TX (US)

(72) Inventor: Jade O. Laye, Fresno, TX (US)

(21) Appl. No.: 16/003,332

(22) Filed: Jun. 8, 2018

(51) Int. Cl. G06Q 10/08; G06Q 20/22

(52) U.S. Cl. CPC G06Q 10/0833; G06Q 20/22

(57) ABSTRACT

The present disclosure provides various methods and systems for passive crowdsourced package delivery. A mobile human task performer uploads information to a server which enables access to his vehicle during a specified time at a first location, such as his home driveway. Using this information, a package courier drops-off a package in the vehicle of the mobile human task performer. Thereafter, during his normal commuting patterns, the mobile human task performer arrives at a second location, such as his place of work. Using the vehicle location and access information provided by the mobile human task performer, a second courier picks-up the package from the vehicle and delivers the package to its final destination.

### FIELD OF THE INVENTION

The present disclosure generally relates to the on-demand transportation and delivery of packages and, more particularly, to systems and methods which utilize passive crowdsourcing to deliver packages.

### BACKGROUND

In recent years, crowdsourced transportation of persons or packages has become quite popular, as these platforms enable everyday people to reap the economic benefits afforded thereby. However, present crowdsourcing platforms require a participant to actively participate in the transactions. For example, ridesharing platforms such as Uber® or Lyft® require the driver to drive to a destination for the sole purpose of picking up persons or packages requiring transportation and/or delivery.

One problem with such platforms is they limit those persons who can participate. For example, busy professionals or other persons having demanding jobs do not have time to pick up and transport persons and/or products. As a result, they are shut out from the economic benefits of crowdsourced transportation and delivery.

### BRIEF DESCRIPTION OF THE FIGURES

FIG. 1 illustrates a communications network for passive crowdsourced package delivery, according to certain illustrative embodiments of the present disclosure; and

FIG. 2 is a flow chart of a method for passive crowdsourced package delivery performed over a communications network, according to certain illustrative methods of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION OF ILLUSTRATIVE EMBODIMENTS

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those ordinarily skilled in the art having the benefit of this disclosure that these concepts may be practiced without these specific details. In some instances, well-known structures and components are shown in block diagrammatical form in order to avoid obscuring such concepts.

The present disclosure provides systems, methods, and non-transitory computer readable media for passive crowdsourced package delivery. More particularly, the present disclosure describes various systems and methods through which packages can be transported passively by mobile human task performers. The disclosed embodiments and methods allow everyday individuals (i.e., mobile human task performers) to passively transport packages as they go about their daily commutes to/from work, school, church, etc., with or without any active participation/intervention on their part. As described herein, the human task performers upload their commute data to a centralized system, whereby the system matches the human task performer to a package transport task entered by a task requestor. Once the match has been confirmed by the system, a courier delivers the package to the specified vehicle of the human task performer and gains access to the vehicle with or without the assistance/intervention of the human task performer. Once the packaged has been dropped-off in the vehicle, the human task performer then commutes using the vehicle as he or she normally does each day. Once the human task performer has arrived at his or her destination, a second courier is alerted by the system and given the data necessary to pick-up the package from the vehicle with or without the assistance of the human task performer. The second courier then delivers the package to its destination. The system then facilitates payment to the human task performer and the couriers for completion of the transport task. Accordingly, since the transport tasks can be completed without any active participation/intervention on the part of the human task performer, the everyday busy man or woman can benefit from a crowdsourced economy as they go about their daily commuting.

In view of foregoing summary, in a generalized method of the present disclosure, a server or other centralized computing system receives information from a mobile human task performer who is available to perform package transport tasks in a geographic location. The received information includes identification data of the vehicle to be used for package transport, a package drop-off time window, a package drop-off location of the vehicle during the drop-off time window, a package pick-up time window, a package pick-up location of the vehicle during the pick-up time window, and data necessary to access the vehicle. The computing system also receives information from a task requestor specifying a package transport task available to be performed. The package transport task information includes criteria for performance of the task, such as a package origination and destination point. The server/computing system then analyzes the information received from the mobile human task performer and the criteria for performance of the package transport task in order to determine if there is a suitable match. If a match is determined, the vehicle identification data, drop-off time window, and drop-off location is communicated to a first package courier, which is then utilized by the courier to gain access to the vehicle in order to drop-off the package in the vehicle at the drop-off location during the drop-off time window. Then, the computing system verifies the package has been dropped-off in the vehicle.

Thereafter, the mobile human task performer enters the vehicle and begins his commute to his predetermined destination. At the same time, known or unbeknownst to the task performer, he is also transporting the package to the package pick-up location. The computing system communicates the vehicle identification data, pick-up time window and pick-up location to a second courier of the package, wherein the second courier gains access to the vehicle therewith to pick-up the package from the vehicle at the pick-up location during the pick-up time window. The computing system confirms the package has been picked-up at the pick-up location and, thereafter, that the package has reached the package destination. Thereafter, the system facilitates payment of one or more of the human task performer, first courier, and second courier.

Accordingly, the illustrative methods/systems described herein allow a mobile human task performer to passively transport packages without any intervention on his or her part (i.e., passive delivery). For instance, a more practical example includes the busy professional (e.g., lawyer) who chooses to passively deliver packages and registers to do so via a graphical user interface (“GUI”) or other suitable interface (e.g., mobile phone app). Perhaps the busy professional would like to passively deliver packages as he drives to work each day. To do so according to a generalized example, the busy professional uploads his information to a centralized computing system via the GUI, such information including his vehicle identification data (e.g., make, model, color, license plate number, etc.), a package drop-off time window (e.g., between 7 pm-6 am on a certain date), a package drop-off location (e.g., home address) of the vehicle during the drop-off time window, a package pick-up time window (e.g., during work hours of 9 am-5 pm), a package pick-up location of the vehicle during the pick-up time window (e.g., work address, parking garage location), vehicle access data (e.g., code to access vehicle trunk, trunk/cabin capacity), and banking account info. This information is received by the computing system and processed in order to match the mobile human task performer with a package transport task.

The computing system also receives (or has previously received) a package transport task request from a task requestor who registers and uploads his information in like manner (e.g., via GUI, app, etc.). In this example, the task requester is a person who lives nearby the busy professional who needs a package delivered to a destination nearby the professional's work address. Hence, the package transport task information would include a package origination (e.g., home/business of task requestor), package destination (e.g., address nearby professional's work address), and a destination delivery time deadline. Once this information has been uploaded, the computing system will analyze the information of the mobile human task performer and the transport task request to determine if there is a match. In one example, a match would exist if the task requester needed a package delivered to a destination within a threshold proximity (e.g., 3 miles) to the package pick-up location specified by the mobile human task performer. Moreover, in this example, a match would exist if the human task performer arrives at work within a time allowing for the package to be delivered at the destination by the deadline set by the task requestor.

Once the computing system determines there is a match, the computing system will communicate the information to a courier necessary to obtain the package from the task requestor and drop-off the package in the busy professional's vehicle. To do so, the information uploaded by the busy professional (e.g., package drop-off time of 7 pm-6 am, home address, and vehicle trunk access code) is communicated to the courier via his mobile phone, for example. Once received, the courier obtains the package from the task requestor, then transports it to the busy professional's home address, where he accesses his vehicle trunk to drop-off the package between the hours of 7 pm-6 am on the specified dates. Access to the vehicle trunk may be achieved in a variety of ways, as described herein. In certain methods, the computing system confirms the package has been dropped off in the vehicle via a suitable means (e.g., bar codes on the package and on the interior of the car trunk may be scanned by the courier during the drop-off).

At some time after 6 am, the busy professional enters his car as usual and commutes to work. Here, note the package was dropped-off in the trunk without any active participation/intervention by the busy professional (i.e., passive). The computing system may track the location of the vehicle via a suitable geo-positioning system. Once the professional arrives at his workplace and parks the vehicle, the computing system then communicates the data necessary to pick-up the package to another courier via, for example, the courier's mobile phone. Such information may include the workplace address, vehicle identification data, package pick-up time window (e.g., during work hours), vehicle trunk access code, and package destination. The courier then arrives at the workplace address, locates the vehicle, and obtains access to the trunk to pick-up the package. The computing system may again confirm the package has been picked up using a suitable means, such as the bar code readings previously described. The courier then transports the package to the package destination. Note, again, the package was picked-up and delivered to the package destination without any intervention of the busy professional (i.e., passively)—he simple commuted to work. Thereafter, the computing system facilitates payment to the busy professional and the couriers for completion of the transport task. Accordingly, the busy professional has generated passive income simply by doing what he normally does—commute to work.

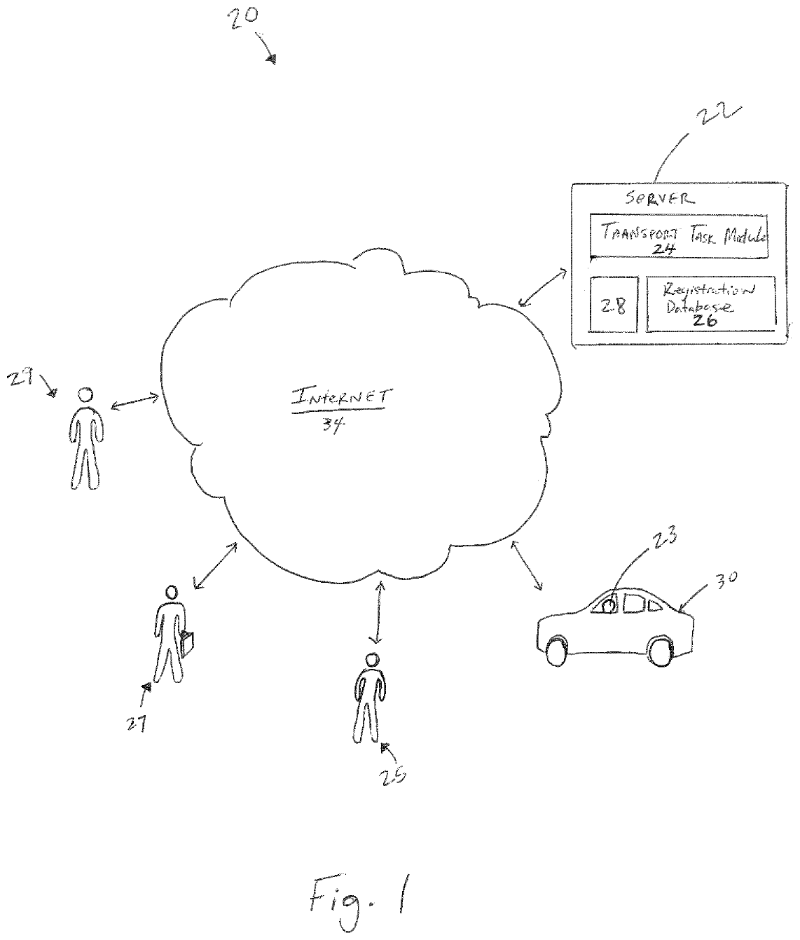

FIG. 1 illustrates a communications network for crowdsourced package deliver, according to certain illustrative embodiments of the present disclosure. Communications network 20 may support operation on multiple carriers (e.g., waveform signals of different frequencies for wireless/wired communications). As an example, communications network 20 may be a multi-carrier LTE network capable of efficiently allocating network resources. Communications network 20 is one example of a network to which various aspects of the disclosure apply.

In the illustrated example, communications network 20 includes a server 22 which contains various processing circuitry/computing devices, databases, modules, etc., to facilitate passive crowdsourced package deliver. Server 22 includes a transport task module 24, a registration database 26, and a geo-positioning module 28. Registration database 26 stores data relating to mobile human task performers 23, first courier 25, package delivery task requestor 27, second courier 29, and vehicle 30 necessary to facilitate the methods described herein. Transport task module 24 is communicably coupled to registration database 26 to process data relating to mobile human task performers 23, first courier 25, package delivery task requestor 27, and second courier 29 in order to facilitate the methods described herein.

Geo-positioning module 28 may receive and/or process user location information (e.g., of vehicles during package transport or while stationary) so that packages may be dropped-off, picked-up, and delivered to package destinations in the most efficient manner. Such geo-positioning data may also be coupled with data pertaining to real-time traffic or weather patterns, to thereby further increase efficiency of the package delivery methods described herein.

Still referencing FIG. 1, when a mobile human task performer 23 desires to passively deliver packages, human task performer 23 uses a device/computer (not shown) to access server 22 via an internet connection or other communications network 34. The computing device of mobile human task performer 23 may display a mobile application, for example, in which human task performer 23 registers and enters his or her relevant information via a suitable graphics interface, whereby the information is uploaded to registration database 26 via internet or other communications network 34. In certain illustrative embodiments, the information entered by mobile human task performer 23 includes identification data of vehicle 30 the human task performer intends to use to perform the package transport, a package drop-off time window, a package drop-off location of vehicle 30 during the drop-off time window, a package pick-up time window, a package pick-up location of vehicle 30 during the pick-up time window, and vehicle access data.

The vehicle identification data may include a vehicle make, model, color, license plate number, or any other useful identification data of the vehicle. The package drop-off time window is the time window in which the package may be dropped-off in the vehicle. For example, the package drop-off time window may be during the hours of 7 pm-6 am. The package drop-off location data (of vehicle 30 during the drop-off time window) is the location of vehicle 30 during the hours of 7 pm-7 am (in this example). The package pick-up time window data is the time window in which the package may be picked-up from vehicle 30 (e.g., during work hours of 8 am-5 pm). The package pick-up location data (of vehicle 30 during the pickup-up time window) is the location of vehicle 30 during the work hours of 8 am-5 pm (e.g., work address).

The vehicle access data may be a variety of identification data including, for example, vehicle cabin or trunk access data, or trunk/cabin capacity data. The access data may be an access code, identification of an unlocked door or trunk, identification of a key location, a digital key, etc. With regard to the identification of an unlocked door/trunk, in certain embodiments human task performer 23 may upload to registration database 26 that a certain door of vehicle 30 (or the trunk) is unlocked. In other examples, the trunk or door(s) of vehicle 30 may be equipped with a specialized access module enabling access to the trunk or door(s). In yet other embodiments, server 22 may have remote control of vehicle 30 such that server 22 can remotely open vehicle 30 during package drop-off or pick-up. Moreover, in yet other embodiments, there may be different access codes to gain access to vehicle 30 during package drop-off and package pick-up. In such embodiments, the vehicle access data communicated to first courier 25 may be different than the access data communicated to second courier 29. With regard to a digital key, human task performer 23 or server 22 may give first or second couriers 25,29 temporary access to vehicle 30 using the digital key. Moreover, the access data may be trunk and/or cabin capacity data of vehicle 30. In one embodiment, human task performer 23 may enter this information, while in other embodiments server 22 may determine the cabin/trunk capacity of vehicle 30 based on, for example, the make and model of vehicle 30. As will be understood by those ordinarily skilled in the art, there are a variety of vehicle access methods which may be integrated into the present disclosure.

The computing device of mobile human task performer 23 may take various forms such as, for example, a mobile device, laptop or other network-adapted computing device. The computing device of mobile human task performer 23 may be location-aware, for example, by including circuitry and/or software to enable the computing device of mobile human task performer 23 to determine its own location and communicate that location to server 22. For example, the computing device of mobile human task performer 23 may include circuitry and/or software that enables it to be in communication with a geo-positioning system and geo-positioning module 28, or other such system that enables the communications network 20 to determine the location of mobile human task performer 23.

In like manner, package delivery task requester 27 is also communicably coupled to server 22 via internet 34. Task requester 27 may be an individual, business, oro other entity desiring package delivery. Task requester 27 may upload package transport task data via a GUI or other suitable interface of a computing device (e.g., handheld device, mobile phone, etc.) (not shown). The package transport task data may include various criteria for performance of the task including, for example, a package origination and package destination. The package may be any variety of items in which delivery is desired (e.g., books, food stuffs, medicine, devices, etc.). The package origination data specifies an original location of the package (where first courier 25 will obtain the package). The original location of the package may be, for example, a home or other location of task requester 27. The package destination data specifies a final destination of the package so that second courier 29 will know where to deliver the package once its picked-up at the package pick-up location.

Alternatively, in certain other methods, task requestor 27 may serve as his own courier to deliver packages to vehicle 30. In such examples, task requestor 27 may simply upload the required delivery criteria to server 22, to thereby enable server 22 to match the task request with a mobile human task performer 23. Task requestor 27 can also inform server 22 at that time that he will act as the courier, whereby server 22 communicates the necessary information so that task requestor 27 can access vehicle 30. Here, as with all other participants in the package delivery process, various participant authorization/security protocol may be utilized.

In a illustrative practical application of the present disclosure, human task performer 23 desiring to passively deliver packages accesses server 22 via internet 34 using his or her computing device. In this example, via a suitable GUI, human task performer 23 enters identification data of vehicle 30, a package drop-off time window of 7 pm-6 am, a drop-off location of his/her home address, a package pick-up time window of Sam-5 pm (work hours of human task performer 23), package pick-up location (work address of human task performer 23), and vehicle access data—where this data is communicated over internet 34 and uploaded to registration database 26. In addition, human task performer 23 may upload information necessary to receive payments such as, for example, bank account information.

Once this data is upload to registration database 26, server 22 now identifies human task performer 23 as being a candidate for passive package delivery. At the same time, registration database 26 has received (or will receive) information from task requestor 27 relating to a package delivery task. Here, task requestor 27 has specified his home address as the package origination location. In addition to a package origination and destination, the transport task data may include criteria relating to a desired time of delivery for the package or any other data relevant to the package transport task.

Using the data received from human task performer 23 and the task performance criteria received from task requestor 27, server 22 matches a human task performer 23 to a package delivery task. Server 22 may perform the matching in a variety of ways. For example, server 22, using geo-positioning module 28, analyzes the package origination location (e.g., home of task requestor) to confirm it is within a threshold proximity to the package drop-off location (e.g., home of human task performer 23). At the same time, server 22 may analyze the package destination location to confirm it's within a threshold proximity to the package pick-up location (e.g., work address of human task performer 23). The threshold proximity may be a distance of up to 10 miles, for example. In other examples, server 22 may compare the required delivery time specified by task requester 27 and the pick-up/drop-off time windows to determine the match. A variety of other match parameters may be used herein. Once server 22 determines these threshold requirements exist, a match is confirmed.

Responsive to the match, server 22 communicates the information uploaded by human task performer 23 (e.g., vehicle identification data, package drop-off/pick-up locations and time windows, etc.) and task requestor 27 (e.g., package origination location) to first courier 25, who receive this data via some computing device (e.g., mobile phone). Using this information, first courier 25 arrives at the home of task requestor 27 to obtain possession of the package and transport it to the home (package drop-off location) of human task performer 23 during hours of 7 pm-6 am (package drop-off window), which may be the sleeping hours of human task performer 23. Once first courier 25 arrives at the home of human task performer 23, the vehicle access data is used to obtain access to vehicle 30 to drop-off the package therein. In this example, note first courier 25 drops off the package without the intervention of human task performer 23, as human task performer 23 is remote from vehicle 30 (asleep in bed) during this time. However, in alternate embodiments, human task performer 23 can also be in the vehicle or otherwise assist first courier 25 in obtaining access to vehicle 30.

In certain illustrative methods, server 22 confirms the package has been dropped-off in vehicle 30. The confirmation may be achieved in a variety of ways as described herein. For example, first courier 25 may scan a bar code on the package and on the interior of the car trunk during the drop-off. In other examples, a camera may be present in the trunk or cabin of vehicle 30 to take a picture/video of the drop-off (picture/video initiated/controlled by the courier or server 22). These same confirmation methods may also be utilized during pick-up confirmation.

The next morning (or sometime after the 6 am end of the drop-off time window), human task performer 23 leaves his home and enters vehicle 30 to begin his commute to work (package pick-up location). Human task performer 23 commutes to work and parks in the parking garage of his building, then proceeds upstairs to his office to begin work. Meanwhile, server 22 communicates (or has already communicated) the information entered by human task performer 23 to second courier 29, who obtains the data via a personal computing device (e.g., mobile phone). Such information may include, for example, the vehicle identification data, pick-up time window (e.g., during work hours of human task performer 23), and the pick-up location (work address of human task performer 23). Using this information, second courier 29 locates vehicle 30 and gains access thereto to pick-up the package during the pick-up time window. Here, again second courier 29 has picked-up the package without any intervention of human task performer 23. However, in other examples, human task performer 23 may be at vehicle 30 to assist. Server 22 may then confirm the package has been picked-up by second courier 29 using suitable methods. Thereafter, second courier 29 delivers the package to the package destination specified by task requestor 27.

Server 22 facilitates payments to human task performer 23, first courier 25, and second courier 29. In certain illustrative embodiments, each of human task performer 23, task requestor 27, first courier 25, and second courier 29 have uploaded their respective banking information to registration database 26. With this information, server 22 can facilitate such payments. In one example, responsive to a confirmation the package has reached the specified package destination, server 22 debits the account of task requestor 27 and credits the accounts of human task performer 23, first courier 25 and second courier 29. To achieve this functionality, server 22 includes the necessary processing circuitry and software to calculate, portion, etc. payments to all parties.

In yet other embodiments, server 22 may facilitate progressive payments to all parties. Here, server 22 facilitates payment to first courier 25 for completion of the package drop-off, then facilitates payment of mobile human task performer 23 for arriving at the package pick-up location (e.g., work address), and facilitates payment to second courier 29 when the package has reached the package destination.

In yet other illustrative methods, vehicle 30 may be an autonomous driving vehicle. Here, human task performer 23 still acts as described herein, except that human task performer 23 doesn't actually drive vehicle 30 (thus, making performance of the package delivery even more passive). Instead, human task performer 23 simply rides in vehicle 30 for his commute. Otherwise, the methods described herein still operate as described.

The various components of communications network 20 may take a variety of forms in which to achieve the methods described herein. For example, one or more of server 22 or the computing devices of mobile human task performer 23, vehicle 30, first courier 25, task requester 27, or second courier 29 may include transceivers, memory, processors, user interfaces, databases, etc., which may be in direct or indirect communication with each other, thus enabling bi-directional communication and processing of the data described herein. The transceivers may include a modem subsystem and a radio frequency (“RF”) unit and be configured to communicate bi-directionally with other devices or network elements. The memory of various elements may include a cache memory (e.g., a cache memory of the processor), random access memory (“RAM”), magnetoresistive RAM (“MRAM”), read-only memory (“ROM”), programmable read-only memory (“PROM”), erasable programmable read only memory (“EPROM”), electrically erasable programmable read only memory (“EEPROM”), flash memory, solid state memory device, hard disk drives, other forms of volatile and non-volatile memory, or a combination of different types of memory. In an embodiment, the memory of various network elements may include a non-transitory computer-readable medium having one or more hardware processors coupled thereto to achieve any of the methods described herein.

The memory of various network elements may store instructions that, when executed by a processor, cause the processor to perform the operations described herein in connection with embodiments of the present disclosure. Instructions may also be referred to as code. The terms “instructions” and “code” may include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processors may include a central processing unit (“CPU”), a digital signal processor (“DSP”), an application-specific integrated circuit (“ASIC”), a controller, a field programmable gate array (“FPGA”) device, another hardware device, a firmware device. Etc. Further, the user interface may be used to display one or more vehicle identification options, package drop-off locations/time windows, package pick-up locations/time windows, vehicle access data and any other application data according to embodiments of the present disclosure. The user interface may also include one or more lights (e.g., LEDs) separate from a touchscreen, a vibration generator, a speaker, a microphone, input for a mouse, input for a keyboard, etc. useful for providing feedback to a user as well as receiving further input therefrom when placing task requests or otherwise.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps or blocks described herein may be changed, combined into composite steps, and/or separated into sub-steps to provide features described herein.

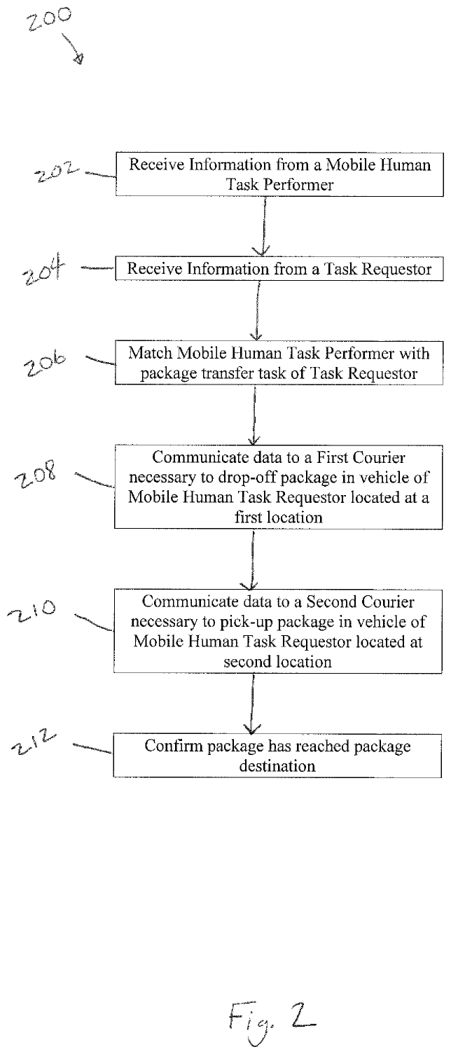

In view of the foregoing, FIG. 2 is a flow chart of a method 200 for passive crowdsourced package delivery over a communications network, according to certain illustrative methods of the present disclosure. With reference to FIGS. 1 and 2, at block 202, via network 34, server 22 acquires information from a mobile human task performer 23 who is available to perform package transport task in a given geographic region. In certain illustrative methods, the information includes identification data of vehicle 30 which his intended to be used for package transports; a package drop-off time window and corresponding location; a package pick-up time window and corresponding location; and access data for vehicle 20.

At block 204, server 22 also receives information from task requestor 27, via network 34, specifying a package transport task he desires to be performed. The package transport task includes criteria for performance of the task including, for example, a package origination and package destination. At block 206, using the information received from mobile human task performer 23 and task requestor 27, server 22 determines whether there is a match. In making this determination, in certain methods, server 22 analyzes the geographic location of human task performer 23, the package drop-off and pick-up data, the package origination and destination points, required package delivery deadlines set by task requestor 27, etc., to determine if a given task performer and task requestor are a match. If there is not a match, server 22 may iteratively continue analysis of the task by analyzing the data of other mobile human task performers who have uploaded their information to server 22 until a match is found.

Nevertheless, once a match is found at block 206, server 22 may also calculate the cost of the transport task and apportion the payments for task completion to task performer 23, first courier 25 and second courier 29. At block 208, server 22 communicates all or a portion of the information uploaded to server 22 by mobile human task performer 23 to first courier 25. This communicated information is necessary for first courier 25 to gain access to vehicle 30 within the necessary package drop-off window and corresponding first location. Using this data, first courier 25 obtains the package from task requester 27 and transports the package to vehicle 30. Once this has occurred, server 22 may also confirm the package has been dropped-off in vehicle 30 by various means, some of which are described herein.

Once the package has been dropped-off in vehicle 30, mobile human task performer 23 enters vehicle 30 and proceeds along his daily commute. During this time (or before such time), in certain methods, at block 210 server 22 communicates to second courier 29 the information uploaded by task performer 23 (in block 202) that enables second courier 29 to obtain access to vehicle 30 at a second location (e.g. work address). Once arrived at the second location, second courier 29 picks-up the package using the vehicle access data.

In certain illustrative methods, server 22 may then confirm the packaged has been picked-up by second courier 29 at the second location. Second courier 29 then transports the package to the destination specified by task requestor 27. Thereafter, at block 212, server 22 confirms the package has reached the package destination by any suitable means used to confirm delivery of packages. Once the package has been confirmed as delivered to its final destination, server 22 facilitates payment to one or more of task performer 23, first courier 25, and second courier 29 for the completed tasks. Alternatively, server 22 may facilitate progressive payments to each participant upon completion of their respective portions of the package delivery.

Embodiments and methods described herein may combine any one or more of the following features:

A computer-implemented method for passive crowdsourced package delivery, the method comprising receiving information from a mobile human task performer who is available to perform package transport tasks in a geographic location, the received information being specified by the mobile human task performer and including: identification data of a vehicle the human task performer intends to use to perform the package transport; a package drop-off time window; a package drop-off location of the vehicle during the drop-off time window; a package pick-up time window; a package pick-up location of the vehicle during the pick-up time window; and vehicle access data; receiving information from a task requester about a package transport task available to be performed, the package transport task having criteria for performance that includes a package origination and package destination; using the received information of the mobile human task performer and the criteria for performance of the package transport task, matching the mobile human task performer to the package transport task; responsive to the match, communicating the vehicle identification data, drop-off time window and drop-off location to a first courier of the package, wherein the first courier gains access to the vehicle therewith to drop-off the package in the vehicle at the drop-off location during the drop-off time window; confirming the package has been dropped-off in the vehicle; communicating the vehicle identification data, pick-up time window and pick-up location to a second courier of the package, wherein the second courier gains access to the vehicle therewith to pick-up the package from the vehicle at the pick-up location during the pick-up time window; confirming the package has been picked-up at the pick-up location; and confirming the package has reached the package destination.

Other combinable features include the method previously described, wherein the mobile human task performer is remote from the vehicle during at least one of the package drop-off or package pick-up. In other methods, the vehicle access data communicated to the first courier of the package is different from the vehicle access data communicated to the second courier of the package. In yet other methods, responsive to a confirmation the package has reached the package destination, payment to one or more of the mobile human task performer, first courier and second courier for completion of the package transport task is facilitated by the system. In other methods, the vehicle access data is at least one of vehicle cabin or trunk access data.

In other methods, the access data is at least one of an access code; identification of an unlocked door or trunk; or identification of a key location. In yet other methods, the first and second couriers obtain access to the vehicle without intervention of the mobile human task performer. In other methods, matching the mobile human task performer to the package transport task comprises confirming the package origination is within a threshold proximity to the package drop-off location; and confirming the package destination is within a threshold proximity to the package pick-up location.

Other combinable features include a computer-implemented method for passive crowdsourced package delivery, the method comprising receiving information from a mobile human task performer who is available to perform package transport tasks, the received information including package drop-off data and package pick-up data specified by the mobile human task performer; receiving information from a task requester about a package transport task available to be performed; matching the mobile human task performer to the package transport task; communicating the drop-off data to a first courier of the package, wherein the first courier gains access to a vehicle of the mobile task performer therewith to drop-off the package in the vehicle at a first location; communicating the pick-up data to a second courier of the package, wherein the second courier gains access to the vehicle therewith to pick-up the package from the vehicle at a second location; and confirming the package has reached a package destination.

In other methods, the first location is a home of the mobile human task performer, and the second location is a job site of the mobile human task performer; or the first location is a job site of the mobile human task performer, and the second location is a home of the mobile human task performer. In yet other methods, the mobile human task performer is remote from the vehicle during at least one of the package drop-off or package pick-up. In other methods, vehicle access data communicated to the first courier of the package is different from vehicle access data communicated to the second courier of the package.

In other methods, payment to one or more of the mobile human task performer, first courier and second courier for completion of the package transport task is facilitated by the system. In yet other methods, at least one of facilitating payment to the first courier for completion of the package drop-off; facilitating payment of the mobile human task performer for arriving at the second location; and facilitating payment of the second courier when the package has reached the package destination. In yet other methods, the first and second couriers obtain access to the vehicle without intervention of the mobile human task performer. In other methods, matching the mobile human task performer to the package transport task comprises confirming a package origination is within a threshold proximity to a package drop-off location; and confirming a package destination is within a threshold proximity to a package pick-up location.

Moreover, any of the methods described herein may be embodied within a system comprising processing circuitry (e.g., non-transitory memory and hardware processor(s) coupled thereto) to implement any of the methods, or a in a non-transitory computer-readable medium comprising instructions which, when executed by at least one processor, causes the processor to perform any of the methods described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art having the benefit of this disclosure will recognize that changes may be made in form and detail without departing from the scope of the present disclosure. Thus, the present disclosure is limited only by the appended claims.

What is claimed is:

1. A computer-implemented method for passive crowdsourced package delivery, the method comprising:
receiving information from a mobile human task performer who is available to perform package transport tasks in a geographic location, the received information being specified by the mobile human task performer and including:
identification data of a vehicle the human task performer intends to use to perform the package transport;
a package drop-off time window;
a package drop-off location of the vehicle during the drop-off time window;
a package pick-up time window;
a package pick-up location of the vehicle during the pick-up time window; and
vehicle access data;
receiving information from a task requester about a package transport task available to be performed, the package transport task having criteria for performance that includes a package origination and package destination;
using the received information of the mobile human task performer and the criteria for performance of the package transport task, matching the mobile human task performer to the package transport task;
responsive to the match, communicating the vehicle identification data, drop-off time window and drop-off location to a first courier of the package, wherein the first courier gains access to the vehicle therewith to drop-off the package in the vehicle at the drop-off location during the drop-off time window;
confirming the package has been dropped-off in the vehicle;
communicating the vehicle identification data, pick-up time window and pick-up location to a second courier of the package, wherein the second courier gains access to the vehicle therewith to pick-up the package from the vehicle at the pick-up location during the pick-up time window;
confirming the package has been picked-up at the pick-up location; and
confirming the package has reached the package destination.

2. The computer-implemented method of claim 1, wherein the mobile human task performer is remote from the vehicle during at least one of the package drop-off or package pick-up.

3. The computer-implemented method of claim 1, wherein vehicle access data communicated to the first courier of the package is different from the vehicle access data communicated to the second courier of the package.

4. The computer-implemented method of claim 1, further comprising, responsive to a confirmation the package has reached the package destination, facilitating payment to one or more of the mobile human task performer, first courier and second courier for completion of the package transport task.

5. The computer-implemented method of claim 1, wherein vehicle access data is at least one of vehicle cabin or trunk access data.

6. The computer-implemented method of claim 5, wherein the access data is at least one of:
an access code;
identification of an unlocked door or trunk; or
identification of a key location.

7. The computer-implemented method of claim 1, wherein the first and second couriers obtain access to the vehicle without intervention of the mobile human task performer.

8. The computer-implemented method of claim 1, wherein matching the mobile human task performer to the package transport task comprises:
confirming the package origination is within a threshold proximity to the package drop-off location; and
confirming the package destination is within a threshold proximity to the package pick-up location.

9. A system, comprising:
a non-transitory memory; and
one or more hardware processors coupled to the non-transitory memory and configured to read instructions from the non-transitory memory to cause the system to perform the operations of claim 1.

10. A non-transitory computer-readable medium having stored thereon machine-readable instructions executable to cause a machine to perform the operations of claim 1.

11. A computer-implemented method for passive crowdsourced package delivery, the method comprising:
receiving information from a mobile human task performer who is available to perform package transport tasks, the received information including package drop-off data and package pick-up data specified by the mobile human task performer;
receiving information from a task requester about a package transport task available to be performed;
matching the mobile human task performer to the package transport task;
communicating the drop-off data to a first courier of the package, wherein the first courier gains access to a vehicle of the mobile task performer therewith to drop-off the package in the vehicle at a first location;
communicating the pick-up data to a second courier of the package, wherein the second courier gains access to the vehicle therewith to pick-up the package from the vehicle at a second location; and
confirming the package has reached a package destination.

12. The computer-implemented method of claim 11, wherein:
the first location is a home of the mobile human task performer, and the second location is a job site of the mobile human task performer; or
the first location is a job site of the mobile human task performer, and the second location is a home of the mobile human task performer.

13. The computer-implemented method of claim 11, wherein the mobile human task performer is remote from the vehicle during at least one of the package drop-off or package pick-up.

14. The computer-implemented method of claim 11, wherein vehicle access data communicated to the first courier of the package is different from vehicle access data communicated to the second courier of the package.

15. The computer-implemented method of claim 11, further comprising facilitating payment to one or more of the mobile human task performer, first courier and second courier for completion of the package transport task.

16. The computer-implemented method of claim 11, further comprising at least one of:
facilitating payment to the first courier for completion of the package drop-off;
facilitating payment of the mobile human task performer for arriving at the second location; and
facilitating payment of the second courier when the package has reached the package destination.

17. The computer-implemented method of claim 11, wherein the first and second couriers obtain access to the vehicle without intervention of the mobile human task performer.

18. The computer-implemented method of claim 11, wherein matching the mobile human task performer to the package transport task comprises:
confirming a package origination is within a threshold proximity to a package drop-off location; and
confirming a package destination is within a threshold proximity to a package pick-up location.

19. A system, comprising:
a non-transitory memory; and
one or more hardware processors coupled to the non-transitory memory and configured to read instructions from the non-transitory memory to cause the system to perform the operations of claim 11.

20. A non-transitory computer-readable medium having stored thereon machine-readable instructions executable to cause a machine to perform the operations of claim 11.
